(19) United States
(12) Patent Application Publication
(10) Pub. No.: US 2025/0289435 A1
(43) Pub. Date: Sep. 18, 2025

(54) METHOD FOR APPROXIMATING A FRICTION VALUE

(71) Applicant: ZF CV Systems Global GmbH, Bern (CH)

(72) Inventors: Benjamin Bieber, Wedemark (DE); Jonas Böttcher, Hannover (DE); Klaus Plähn, Seelze (DE); Oliver Wulf, Neustadt (DE)

(21) Appl. No.: 19/221,389

(22) Filed: May 28, 2025

Related U.S. Application Data
(63) Continuation of application No. PCT/EP2023/083854, filed on Dec. 1, 2023.

(30) Foreign Application Priority Data
Dec. 20, 2022 (DE) 10 2022 134 145.3

(51) Int. Cl. B60W 30/18; B60W 30/02; B60W 40/10; B60W 40/13; G01N 19/02

(52) U.S. Cl. CPC B60W 30/18172; B60W 30/02; B60W 40/1005; B60W 40/13; G01N 19/02; B60W 2040/1307; B60W 2040/1315; B60W 2510/182; B60W 2520/10; B60W 2520/105; B60W 2520/26; B60W 2520/28; B60W 2520/30; B60W 2530/10; B60W 2710/182

(57) ABSTRACT

A method approximates a friction value between wheels of a vehicle and a road surface. The method includes the following steps: carrying out at least one test acceleration of the vehicle by acting on at least one test wheel; ascertaining a wheel slip of the test wheel for at least one period of the test acceleration; ascertaining a test manipulated variable provided during the period in order to act on the test wheel; ascertaining a test load characteristic present on the test wheel during the period; and ascertaining a reference friction value for the test acceleration on the basis of the ascertained test load characteristic, the ascertained test manipulated variable and the ascertained wheel slip of the test wheel. A driver assistance system is configured to perform the method. A vehicle includes the driver assistance system.

### CROSS-REFERENCE TO RELATED APPLICATIONS

This application is a continuation application of international patent application PCT/EP2023/083854, filed Dec. 1, 2023, designating the United States and claiming priority from German application 10 2022 134 145.3, filed Dec. 20, 2022, and the entire content of both applications is incorporated herein by reference.

### TECHNICAL FIELD

The disclosure relates to a method for approximating a friction value between the wheels of a vehicle and a road surface. The disclosure also relates to a driver assistance system, a vehicle and a computer program product.

### BACKGROUND

The ability of a vehicle to change its speed or direction substantially depends on the forces that the vehicle's tires can transfer to a road surface. The most important factor influencing the forces that can be transmitted is the friction value between the road and the vehicle's tires. This friction value is influenced by the vehicle's tires and the properties of the road surface. The road surface properties in particular can vary considerably over the course of a journey.

A human driver assesses the road surface conditions visually through the vehicle's windshield and/or acoustically through the rolling noise of the vehicle's wheels on the road surface. A human driver uses experience and knowledge about the current tires and steering behavior of the vehicle and also takes current weather conditions into account. The current friction value is key for safe vehicle control, as the driving style can be adapted with the help of this information by comparing the intended vehicle movement with the actual vehicle movement. In this way, an experienced driver continuously estimates which longitudinal and lateral accelerations are safely possible for the vehicle. Many years of experience are crucial for correctly estimating the forces that can be transmitted to the road surface to guide the vehicle and thus also the possible changes in vehicle movement. Inexperienced drivers in particular may misjudge the friction value between the vehicle's wheels and the road surface, which poses a considerable risk of accidents. A reliable assessment of the friction value is also key for the safe operation of autonomous vehicles.

Sensor-based approaches for the automated assessment of road surface conditions are well known. For example, optical sensors are available that optically detect a road surface in front of the vehicle and evaluate the optically captured image data in order to estimate the adhesion conditions between the vehicle's tires and the road surface. However, these sensors have several disadvantages. Firstly, the results are heavily influenced by the characteristics of the sensor and may not be applicable in all driving situations. For example, systems that use conventional cameras can only be used during the day due to poor lighting conditions. Furthermore, optical systems only take into account aspects of the road surface and neglect vehicle-specific aspects, such as the properties of the vehicle's tires in particular.

### SUMMARY

It is an object of the disclosure to provide a method for approximating a friction value between the wheels of a vehicle and a road surface, a driver assistance system, a vehicle and/or a computer program product, which is preferably sufficiently accurate, enables improved safety and/or can be used reliably.

In a first aspect, the disclosure solves the aforementioned problem via a method of the type mentioned at the outset, which has the following steps: carrying out at least one test acceleration of the vehicle by acting on at least one test wheel; ascertaining a wheel slip of the test wheel for at least one period of the test acceleration; ascertaining a test manipulated variable provided during the period in order to act on the test wheel, ascertaining a test load characteristic present on the test wheel during the period; and ascertaining a reference friction value for the test acceleration on the basis of the ascertained test load characteristic, the ascertained test manipulated variable and the ascertained wheel slip of the test wheel. It should be understood that the ascertainment of the reference friction value can be subject to errors, so that the ascertained reference friction value can also deviate from a real friction value with an error (e), as is also known in principle when measuring physical variables.

The disclosure is based on the realization that the wheel slip of wheels of the vehicle can be used to ascertain a friction value between the wheels of the vehicle and the road surface. Furthermore, the disclosure is based on the realization that not only an effective torque applied to the test wheel, which is intended to act on the test wheel, but also a load on the test wheel is of decisive importance. This load on the test wheel is taken into account by the test load characteristic. The reference friction value can thus be ascertained simply and/or precisely from the ascertained test load characteristic, the ascertained test manipulated variable and the ascertained wheel slip of the test wheel. Advantageously, no environment sensors, such as cameras or radar sensors, are required for this. The method can be implemented particularly cost-effectively and reliably.

The friction value ascertains the maximum forces that can be transmitted between the vehicle and the road surface. Preferably, the action on the test wheel is a provision of an effective torque on the test wheel. The effective torque is provided by an actuator of the vehicle to change a vehicle movement and is not a torque resulting from the rolling of the vehicle on the road. Preferably, the effective torque is a braking torque or an acceleration torque for the test wheel. The test manipulated variable is a manipulated variable provided on a vehicle actuator, wherein the vehicle actuator is intended to act on the test wheel. For example, the manipulated variable can be a motor torque of a drive motor that drives the test wheel. If the test acceleration is a deceleration of the test wheel, then the manipulated variable can be, for example, a brake pressure of a brake cylinder associated with the test wheel.

In a first embodiment, ascertaining a wheel slip for at least one period of the test acceleration includes: ascertaining a test rotational speed of the test wheel; ascertaining a reference rotational speed of a reference wheel; and ascertaining the wheel slip on the basis of the ascertained test rotational speed and the ascertained reference rotational speed, wherein the reference wheel is a wheel rolling freely during the period. The test wheel is therefore acted upon during the test acceleration, while the reference wheel is free-rolling. A free-rolling wheel is not subjected to an effective torque by a vehicle actuator. However, it should be understood that torques can also act on a free-rolling wheel due to interaction with the road surface and/or frictional effects. The difference between the reference wheel and the test wheel lies in the deliberate action, which is only intended for the test wheel. For example, the test wheel can be selectively braked via an associated brake, while brakes associated with the reference wheel are open. The free-rolling reference wheel has approximately no slip, so that a rolling speed of the wheel substantially corresponds to a speed of the vehicle. On the test wheel, however, slip occurs due to the effect. This slip corresponds to the test speed of the test wheel. The test speed and the reference speed of the reference wheel can therefore be used to ascertain the wheel slip.

According to various embodiments, the test wheel and the reference wheel are associated with different axles of the vehicle. This makes it particularly easy to act on the test wheel while at the same time the reference wheel is free-rolling. Furthermore, a wheel of an axle that has a comparatively small or no part in providing the test acceleration can be selected as the reference wheel. However, it is also possible for the test wheel and the reference wheel to be wheels on the same axle of the vehicle. The reference wheel is preferably a wheel of a liftable additional axle of the vehicle, which is lowered during the period. Liftable additional axles of the vehicle can be raised if necessary in order to reduce wear, reduce fuel consumption of the vehicle and/or save tolls. To transport heavy loads, on the other hand, the liftable auxiliary axle can be lowered so that the load is distributed over an additional axle of the vehicle. Furthermore, lowering the lift axle can be advantageous in order to fall below axle load limits when driving over bridges. Compared to other axles of the vehicle, the liftable additional axle often makes a smaller contribution to changes in the longitudinal or lateral dynamics of the vehicle, so that the influence of a reference wheel arranged on the liftable additional axle on the driving dynamics of the vehicle is minimal.

According to various embodiments, the test wheel is a wheel of a rear axle of the vehicle, in particular an auxiliary axle of the vehicle. It should be understood that the vehicle may also have several rear axles. In general, a front axle of the vehicle is its steered axle. Steered axles are particularly critical for the driving stability of the vehicle. Preferably, however, the test wheel is a wheel of which the influence on the yaw behavior of the vehicle is minimal. As a rule, these are wheels on the rear axle of the vehicle. Additional axles in particular, which can be liftable, are generally less loaded, making their wheels particularly suitable as test wheels. For axles with a lower load, there is greater slip for the same deceleration than for axles with a higher load, so that wheels on axles with a lower load are particularly suitable as test wheels.

According to various embodiments, the method further includes: ascertaining an operating wheel slip of the test wheel in an operating driving situation; ascertaining a current load characteristic of the vehicle in the operating driving situation; ascertaining a manipulated variable provided in the operating driving situation in order to act on the test wheel; ascertaining a current friction value of the operating driving situation by selecting a corresponding reference friction value, wherein the reference friction value corresponds to the current friction value if the ascertained load characteristic is within a load tolerance around the test load characteristic, the operating wheel slip is within a slip tolerance around the wheel slip and the manipulated variable is within a manipulated variable tolerance around the test manipulated variable. An operating driving situation is a driving situation that occurs during normal operation of the vehicle, for example braking of a vehicle approaching a traffic light. A current friction value present in the operating driving situation can be ascertained particularly easily using the development of the method described above. The load characteristics, the operating wheel slip and the manipulated variable, which are generally easily available in normal driving mode, can be used to reliably ascertain the friction value. For example, the operating wheel slip and the manipulated variable can be continuously ascertained by a vehicle brake system and be available. The selection is easily possible by using the parameter combination of manipulated variable, operating wheel slip and load characteristic. The current friction value is preferably ascertained on the basis of reference friction values learned during test braking. It should be understood that a large number of test braking operations can be carried out to approximate a large number of reference friction values, so that a broad basis is available for selecting the current friction value.

According to various embodiments, the method further includes carrying out a subsequent operation using the current friction value, wherein the subsequent operation is or includes providing a warning signal, placing a stability control system in a preventive control mode, re-ascertaining a trajectory of the vehicle, providing a speed reduction request, ascertaining a degree of freedom of movement limit, limiting a degree of freedom of movement of the vehicle and/or validating a friction value sensor. A speed reduction request prompts the driver of the vehicle to reduce the speed of the vehicle. This can be done by corresponding signals to an autonomous unit or, for example, by an indication on a display. Preferably, the subsequent operation is only carried out if the current friction value falls below a friction value limit. For example, a warning signal can only be issued if the friction value falls below the friction value limit. This can be the case, for example, if the vehicle is driving on a road in winter road conditions. The warning signal is preferably an optical, acoustic and/or haptic warning signal. However, it is also possible for the warning signal to be an electrical warning signal that is provided at a control unit of the vehicle. The trajectory includes at least one planned path to be traveled by the vehicle to complete a driving task. Furthermore, the trajectory includes a driving dynamics specification. This driving dynamics specification is or preferably includes a predefined speed for driving along the path or a predefined speed profile for driving along the path. The trajectory is ascertained by a fully or semi-autonomous unit, such as an automatic distance control system or an autonomous control unit, also known as a virtual driver. The re-ascertainment of the planned trajectory can be a complete re-ascertainment of the planned trajectory, a partial re-ascertainment of the planned trajectory and/or an updating of the planned trajectory. Partial re-ascertainment occurs, for example, when a path curve or a path encompassed by the planned trajectory is retained and at the same time a speed profile corresponding to the path curve that is encompassed by the planned trajectory is re-ascertained. During partial re-ascertainment, preferably all the information and/or data on which the trajectory planning is based is re-ascertained. When updating, preferably only some of the information and/or data on which the trajectory planning is based is re-ascertained. The ascertained friction value and/or the ascertained driving dynamics limit value is preferably taken into account in the trajectory, which can increase safety when using the vehicle. Compliance with the driving dynamics limit value ensures safe and stable driving of the vehicle in normal operation. Preferably, the driving dynamics limit value is or includes a maximum permissible vehicle speed, a maximum permissible lateral acceleration, a maximum permissible vehicle acceleration, a maximum permissible vehicle deceleration, a maximum permissible steering angle gradient, a maximum permissible steering frequency or a minimum permissible curve radius of the vehicle.

According to various embodiments, the test acceleration is a test braking of the vehicle, the test manipulated variable is a brake pressure that is provided at a brake actuator associated with the test wheel, wherein the reference wheel is excluded from the test braking so that no brake pressure is provided at a brake actuator associated with the reference wheel during the period. Braking is a negative acceleration of the vehicle that leads to a reduction in the speed of the vehicle. In conventional vehicle brakes, the brake actuator is a brake cylinder that is actuated by a pressurized fluid. When applied, the brake cylinder applies the brakes. The brake actuator associated with the test wheel is configured to provide a braking torque on the test wheel. The brake pressure is the manipulated variable that leads to the provision of the braking torque. The reference wheel is excluded from the test braking and is free-rolling. This means that no brake pressure is provided at the brake actuator of the reference wheel during the period.

According to various embodiments, only the reference wheel is excluded from the test braking during the period. This minimizes the reduction in braking power caused by excluding the reference wheel from the test braking. Furthermore, a particularly good correlation between the reference friction value and the current friction value can be achieved.

According to various embodiments, the test braking is a normal braking operation that is carried out during normal operation of the vehicle to fulfill a driving task. This means that the test braking can also be carried out when the vehicle is in regular driving mode. The test braking therefore does not have to take place on a closed-off test area. The special feature of test braking here is that, in contrast to regular braking of the vehicle, in which all brake actuators are generally used to brake the vehicle, the reference wheel is free-rolling or the brake actuator of the reference wheel is not activated. Normal braking can, for example, be the braking of a vehicle rolling towards a red traffic light.

According to various embodiments, the test braking is a braking operation in which the test wheel is braked more strongly than other braked wheels of the vehicle by redistributing the braking force. The total braking force required for the vehicle can remain unchanged. In this way, the friction value can be ascertained with substantially identical deceleration performance of the vehicle compared to regular braking. The braking force distribution adapts the braking power provided by or on the individual wheels, which corresponds to the braking force of the brake actuators associated with the wheels, in such a way that a slip occurs on the test wheel even with low absolute decelerations of the vehicle, which is suitable for ascertaining the friction value. Due to the brake force redistribution, the procedure can be carried out substantially unnoticed by a driver of the vehicle. The procedure is therefore particularly suitable for test braking, which is normal braking.

In a variant of the method, only the at least one test wheel is braked during the period. In this variant, the influence of the test braking on the vehicle can be minimized. For example, when the vehicle is driving straight ahead at a substantially constant speed, the test wheel can be braked moderately and a reference friction value can be ascertained.

According to various embodiments, the test braking is a demand braking initiated to ascertain the reference friction value and is initiated without an associated deceleration requirement of the vehicle. It is particularly preferable for the demand braking to be initiated when the vehicle is driving straight ahead. The reference friction value can thus be carried out in comparatively uncritical driving situations. Demand braking can also be referred to as brake request on demand and is preferably initiated solely for the purpose of ascertaining the reference friction value. However, it is also possible to ascertain further reference values during the demand braking. Demand braking can preferably be integrated into a regular driving task of the vehicle so that the reference friction value can be ascertained, for example, even if the vehicle does not perform any normal braking suitable for ascertaining the reference friction value. For example, a reference friction value can be ascertained via demand braking even if the vehicle is driving at a substantially constant speed on a straight stretch of highway without carrying out normal braking. No deceleration requirement preferably means that no deceleration of the vehicle is necessary to fulfill a driving task of the vehicle at the time of the demand braking. Preferably, the vehicle is decelerated by a maximum of 0.5 m/s² or less, particularly preferably by 0.2 m/s² or less, when carrying out demand braking.

The period preferably has a value of greater than 0 s to 5 s, particularly preferably from 1 s to 2 s. A period within this value range can be used to achieve sufficient accuracy when ascertaining the reference friction value on the one hand and, on the other hand, to achieve the least possible impairment of the vehicle's behavior.

According to various embodiments of the method, the test braking is a moderate braking in a range of greater than 0 m/s² to 2 m/s², in particular 1 m/s² to 2 m/s2. In the preferred deceleration range, the dynamic vehicle behavior of the vehicle is stable and there is generally no emergency situation, so that the test braking can be carried out particularly safely in the preferred range. If the reference wheel is excluded from the test braking, it does not provide any deceleration power or does not cause any deceleration. The method therefore preferably includes brake force redistribution, wherein other braked wheels of the vehicle compensate for the lack of deceleration of the reference wheel. The other wheels are therefore braked in such a way that the deceleration of the vehicle for the test braking is substantially identical to a deceleration that occurs without excluding the reference wheel from the braking.

According to various embodiments, test acceleration is a positive acceleration of the vehicle and the test manipulated variable is a drive torque provided at the test wheel, wherein no drive torque is provided at the reference wheel during the period. A positive acceleration leads to an increase in the speed of the vehicle. The reference wheel is again free-rolling, but can still be subjected to a torque that is not a drive torque (for example, due to friction on the road surface). Preferably, the reference wheel for the test acceleration is a wheel of a non-driven axle. A positive test acceleration allows the method to be carried out particularly safely, as acceleration situations are generally less critical than braking situations. Preferably, the method can include both test braking and positive test acceleration. This means that a particularly large number of driving situations can be used to ascertain one or more reference friction values.

According to various embodiments, the test load characteristic is or includes an axle load on a test axle of the vehicle on which the test wheel is arranged, a wheel load of the test wheel, a mass distribution of the vehicle, a total mass of the vehicle, a partial mass of a vehicle part on which the test wheel is arranged, a center of gravity position of the vehicle and/or a center of gravity position of a vehicle part. An axle load of the test axle correlates particularly well with the friction value present on the test wheel and is therefore particularly suitable as a test load characteristic. However, it should be understood that the test load characteristic can also be a different load characteristic. For example, an axle load of the test axle can also be inferred from a relative mass distribution of the vehicle and a total mass of the vehicle. Furthermore, the axle load of the test axle does not have to be ascertained, as other load characteristics also correlate with the reference friction value.

In a second aspect, the disclosure solves the problem stated at the outset with a driver assistance system which is configured to carry out the method according to the first aspect of the disclosure. Preferably, the driver assistance system includes a control unit and an interface which can be connected to a vehicle network of the vehicle. The interface is preferably configured to receive vehicle signals representing the reference speed, the test speed, the test load characteristic, the load characteristic, the wheel slip, the operating wheel slip, the manipulated variable and/or the test manipulated variable. It should be understood that one or more of the ascertaining steps of the method can be performed by the driver assistance system on the basis of such vehicle signals. The driver assistance system therefore does not have to ascertain the load characteristic directly itself, for example, but can also ascertain it on the basis of load signals provided by an air suspension system of the vehicle on the vehicle network, for example.

In a third aspect, the disclosure solves the problem stated at the outset via a vehicle with at least two axles, a brake system, a steering system, a drive motor and a driver assistance system in accordance with the second aspect of the disclosure.

According to a fourth aspect of the disclosure, the problem stated at the outset is solved via a computer program product which has program code means which are stored on a computer-readable data carrier in order to carry out the method according to the first aspect of the disclosure when the computer program product is executed on a computing unit, in particular the control unit of the driver assistance system according to the second aspect of the disclosure.

### BRIEF DESCRIPTION OF DRAWINGS

The invention will now be described with reference to the drawings wherein:

FIG. 1 is a plan view of a schematically depicted vehicle;

FIG. 2A is a test braking of the vehicle carried out as normal braking;

FIG. 2B is a test braking of the vehicle carried out as demand braking;

FIG. 2C is a positive test acceleration of the vehicle; and,

FIG. 3 is a schematic flow chart of a method for approximating a friction value.

### DETAILED DESCRIPTION

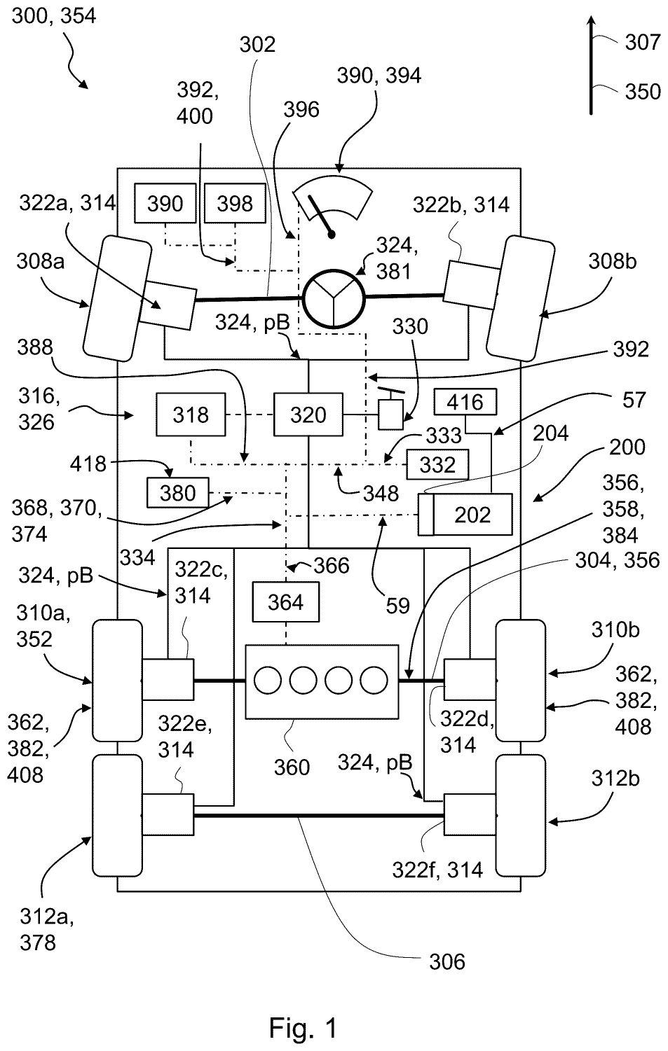

FIG. 1 shows a vehicle 300 with a front axle 302, a rear axle 304 and a liftable additional axle 306, which is arranged behind the rear axle 304 in the direction of travel 307. The liftable additional axle 306 (lift axle 306 for short) can be raised or lifted so that the mass of the vehicle 300 or a weight force resulting from the load is only distributed over the front wheels 308 of the front axle 302 and the rear wheels 310 of the rear axle 304. When the lift axle 306 is lowered, the weight of the vehicle 300 is additionally distributed to additional wheels 312 of the lift axle 306.

The vehicle 300 has several vehicle actuators 314, which are configured to influence the longitudinal dynamics and lateral dynamics of the vehicle 300. For this purpose, the vehicle actuators 314 influence several degrees of freedom of movement of the vehicle 300. A brake system 316 is provided for braking the vehicle 300 and includes a brake control unit 318, a brake modulator 320 and several brake actuators 322. The brake actuators 322 are associated with the wheels 308, 310, 312 of the vehicle 300 and are configured to provide a braking torque 313 at the wheels 308, 310, 312. For example, a brake actuator 322c provides a braking torque 313 at a left rear wheel 310a of the vehicle 300. The braking torque 313 controlled by the brake actuators 322 at the respective wheel 308, 310, 312 corresponds to a manipulated variable 324, which is provided at the respective brake actuator 322. In this case, the brake system 316 is a pneumatic brake system 316. The actuating variable 324 provided at the brake actuators 322 is therefore a brake pressure pB. This brake pressure pB is provided by the brake modulator 320 at the brake actuators 322. In the simplified representation according to FIG. 1, the brake modulator 320 provides the brake pressure pB at several brake actuators 322. However, it should be understood that the brake pressures pB provided at the brake actuators 322 may differ from one another. For example, a brake pressure pB at brake actuators 322a, 322b of the front wheels 308a, 308 may be different from a brake pressure pB at brake actuators 322c, 322d associated with the rear wheels 310a, 310b. Furthermore, the brake pressures pB on brake actuators 322 of wheels of the same axle 302, 304, 306 can also be different from one another.

In the present embodiment, the brake system 316 is an electronic brake system 326. The brake control unit 318 controls the brake modulator 320 on the basis of electronic brake signals 328. The brake control unit 318 receives these brake signals 328 from an electronic foot brake pedal 330 of the vehicle 300. Further, the vehicle 300 here is a semi-autonomous vehicle 300 that is partially controlled by an autonomous unit 332. The autonomous unit 332 is connected to the brake control unit 318 via a vehicle network 334, which here is a CAN bus system, and is configured to provide the brake signals 328 on the vehicle network 334 or for the brake control unit 318. The autonomous unit 332 is configured here to plan a trajectory 333 for the vehicle 300, which includes both a planned path 335 and a speed profile 337 corresponding to the path 335. For example, the autonomous unit 332 may be configured to provide a distance and lane keeping function, wherein the autonomous unit 332 then provides braking signals 328 to brake the vehicle 300 when a distance to a vehicle ahead (not shown in the figures) is to be increased. However, when steering the vehicle 300, braking signals 328 provided by the electronic foot brake pedal 330 preferably have priority over braking signals 328 provided by the autonomous unit 332.

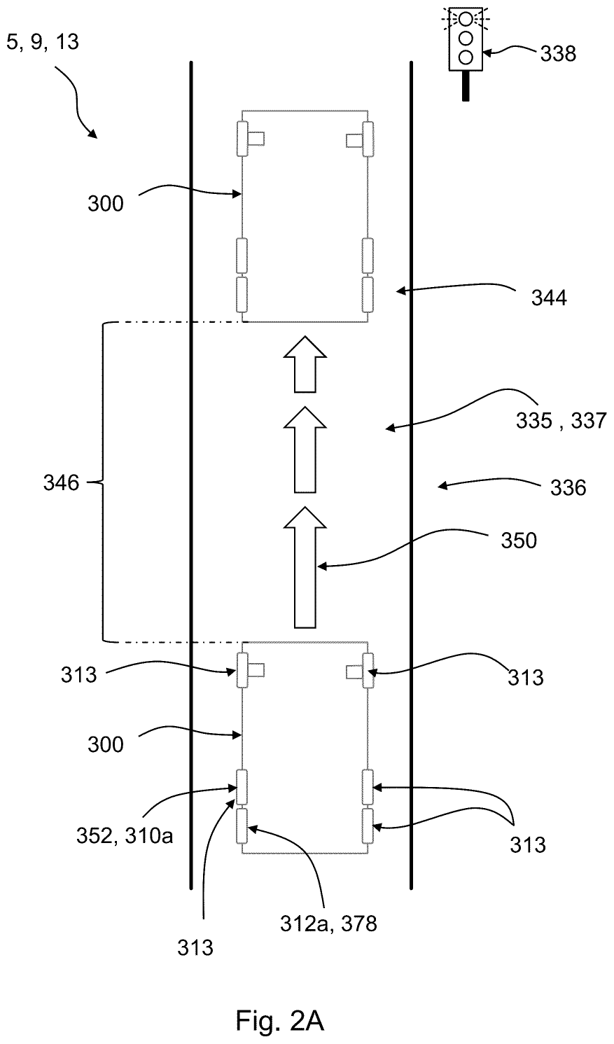

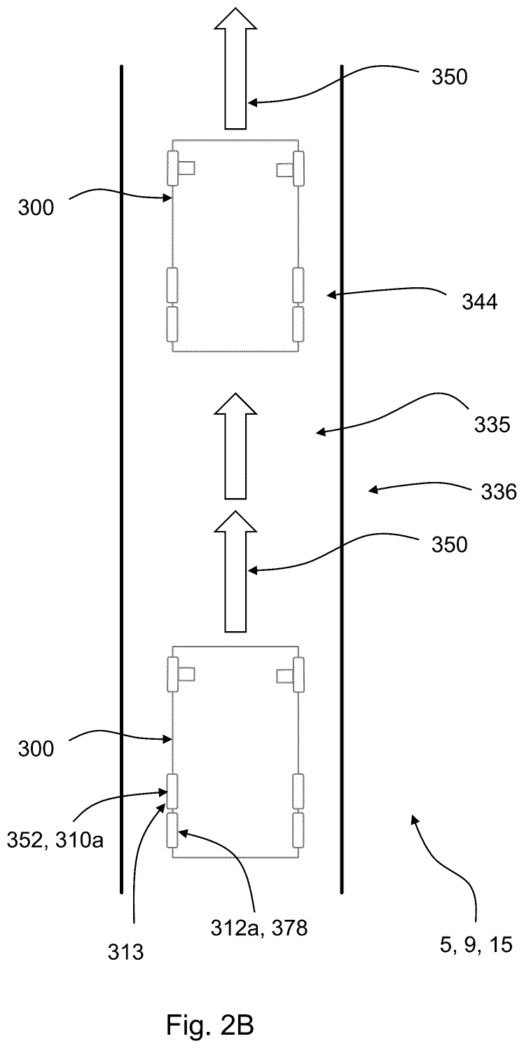

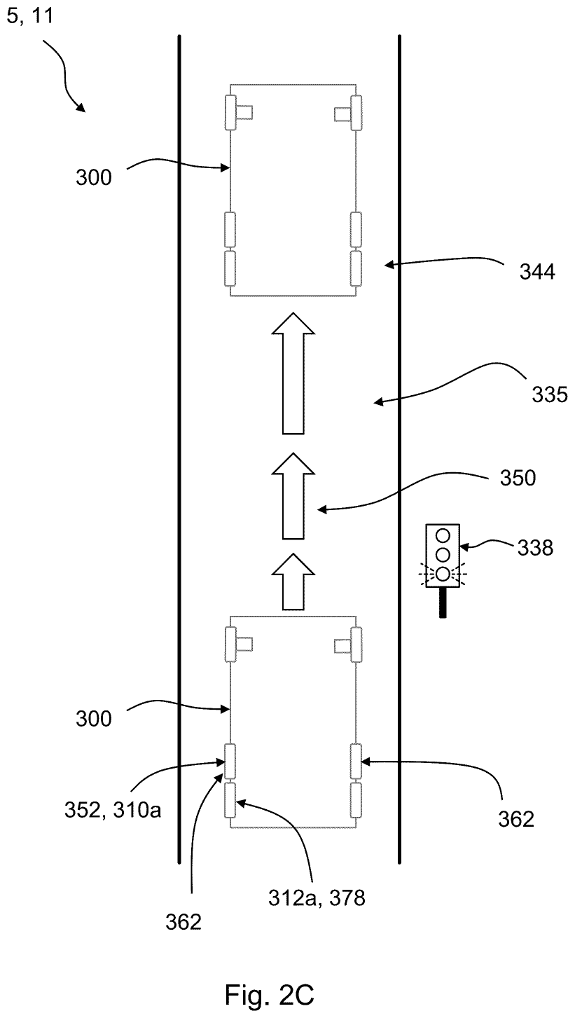

As a result of the brake pressure pB being provided, the brake actuators 322 act on the wheels 308, 310, 312. A braking action 336 of the vehicle 300 caused by this is illustrated in FIG. 1 via arrows of which the length is reduced in the direction of travel 307. FIG. 2A illustrates a vehicle 300 moving in the direction of travel 307 towards a red traffic light 338. Braking 336 is also illustrated in FIG. 2A via arrows of which the length is reduced in the direction of travel 307. The braking action 336 shown in FIG. 2A is a normal braking action 13, which is necessary to fulfill a driving task of the vehicle 300, which in the embodiment shown is a stopping of the vehicle 300 before the red traffic light 338. A negative acceleration of the vehicle 300 achieved during braking 336 of the vehicle 300 is not exclusively influenced by the brake pressure pB provided at the brake actuators 322, but also by a current friction value 7 between the wheels 308, 310, 312 of the vehicle 300 and a road surface 344 traveled by the vehicle 300. Thus, a braking distance 346 of the vehicle 300 at identical brake pressure pB at the brake actuators 322 of the wheels 308, 310, 312 may be different for different friction values 7. For example, the braking distance 346 can be increased compared to a normal situation on a dry road surface 344 if the road surface 344 is wet. Knowledge of the friction value 7 is therefore advantageous for safe control of the vehicle 300. Preferably, the autonomous unit 332 is configured to ascertain the braking signals 328 using the current friction value 7. In this way, the autonomous unit 332 can brake the vehicle 300 appropriately for the situation and the risk of an accident is reduced.

The vehicle 300 here further includes a driver assistance system 200 which, in the embodiment shown, is configured, inter alia, to ascertain the current friction value 7. However, it should be understood that such an ascertainment 39 of the current friction value 7 is not an essential feature of the present disclosure. The driver assistance system 200 includes a control unit 202 and an interface 204, which is connected to the vehicle network 334. Via the interface 204, the driver assistance system 200 can receive signals provided on the vehicle network 334, such as the braking signals 328. Furthermore, the driver assistance system 200 receives manipulated variable signals 348 provided by the brake control unit 318 on the vehicle network 334, which represent the brake pressure Pb provided at the brake actuators 322.

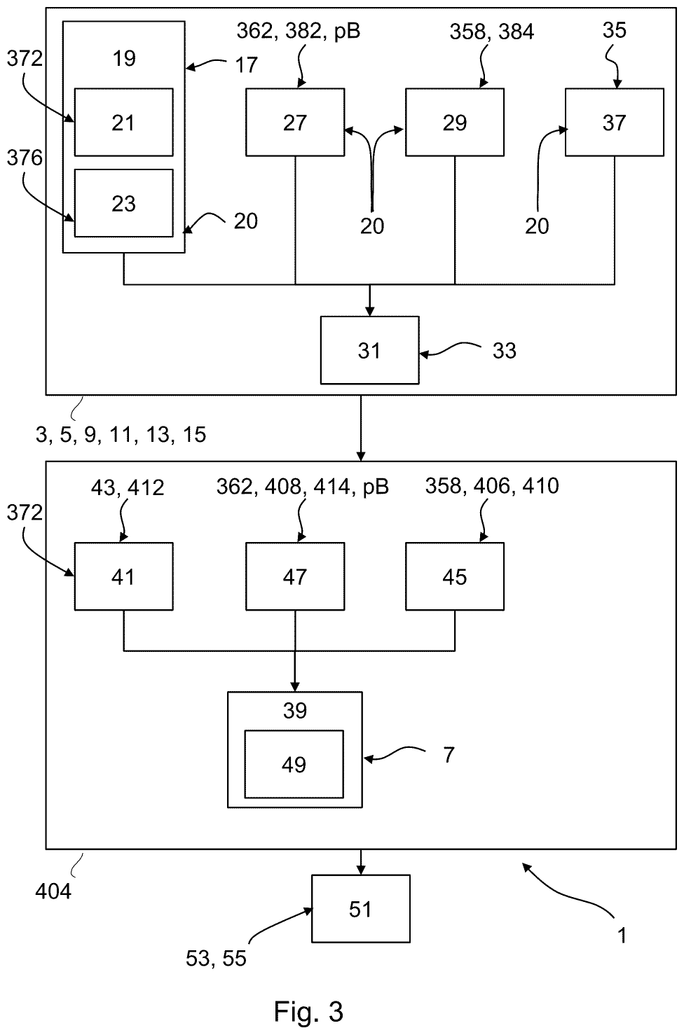

The driver assistance system 200 is configured to carry out the method 1 described below with reference to FIG. 3 for approximating a friction value 7, 33 between wheels 308, 310, 312 of the vehicle 300 and the road surface 344.

In a first step of the method 1, a test acceleration 5 of the vehicle 300 is carried out 3. The test acceleration 5 of the vehicle 300 can be a test braking 9 or a positive test acceleration 11 of the vehicle 300. One example of a test braking 9 is the normal braking 13 illustrated in FIG. 2A. Another example of a test braking 9 is a demand braking 15 of the vehicle 300 illustrated in FIG. 2B. FIG. 2C, on the other hand, illustrates a positive test acceleration 11 of the vehicle 300, in which a speed 350 of the vehicle increases. To perform the test acceleration 5, a vehicle actuator 314 acts on a test wheel 352 of the vehicle 300. In the case of test braking 9, the vehicle actuator 314 is a brake actuator 322 of the vehicle 300. In the embodiment considered, the test wheel 352 is a left rear wheel 310a of the vehicle 300. The selection of a rear wheel 310 as the test wheel 352 is advantageous in that the vehicle 300 is a commercial vehicle 354 of which the rear axle 304 is a maximum load axle 356 of the vehicle 300. Of the three axles 302, 304, 306 of the vehicle 300, the rear axle 304 has a maximum axle load 358. The effects caused by the action on the test wheel 352 are thus particularly large and can be reliably ascertained.

In the case of a positive test acceleration 11, the vehicle actuator 314 in the embodiment shown is a drive motor 360 of the vehicle 300, which also acts on the left rear wheel 310a, which here forms the test wheel 352. In the embodiment shown, the left rear wheel 310a is thus the test wheel 352 both for the test braking 9 and for the positive test acceleration 11. However, it may also be provided that a test wheel 352 considered during a positive test acceleration 11 is a wheel 308, 310, 312 of the vehicle 300 that is different from a test wheel 352 considered during a test braking 9. To act on the test wheel 352, the drive motor 360 provides a drive torque 362 to the test wheel 352 as a manipulated variable 324. However, it should be understood that the drive torque 362 can also be provided to other wheels in addition to the test wheel 352, particularly if these wheels are connected to the test wheel 352 via a differential. A motor control unit 364 connected to the vehicle network 334 controls the drive motor 360 and provides corresponding motor control signals 366 on the vehicle network 334. The driver assistance system receives these control signals 366. Instead of the drive torque 362, however, the manipulated variable 324 can also be, for example, a fuel quantity provided at the engine 360.

As a result of the action on the test wheel 352, a wheel slip 17 forms on this test wheel 352 during the test acceleration 5. The wheel slip 17 is a deviation between a distance traveled by the test wheel 352 and a distance traveled relative to the road surface 344. The wheel slip 17 of the test wheel 352 is ascertained in a second step of the method 1, wherein this ascertainment 19 is carried out for at least one period 20 of the test acceleration. The time segment 20 has a duration of 1.5 s in the embodiment under consideration.

To ascertain 19 the wheel slip 17, the control unit 202 of the driver assistance system 200 receives wheel speed signals 368 from the vehicle network 334 via the interface 204. The wheel speed signals 368 here include a test speed signal 370, which represents a test speed 372 of the test wheel 352. Furthermore, the wheel speed signals 368 include a reference speed signal 374. The reference speed signal 374 represents a reference speed 376 of a reference wheel 378. The reference wheel 378 is a left auxiliary wheel 312a. The test wheel 352 arranged on the rear axle 304 and the reference wheel 378 are thus arranged on different axles 304, 306 of the vehicle 300 in the embodiment shown. The reference wheel 378 could in principle also be a front wheel 308 of the front axle 304. Preferably, however, the reference wheel 378 is a wheel of the rear axle 304 or the auxiliary axle 306. By providing the reference wheel 378 on an unsteered axle 304, 306, unwanted steering effects can be prevented which occur on steered axles (for example, the front axle 302) as a result of asymmetrical interventions. The reference wheel 378 is a free-rolling wheel 308, 310, 312 of the vehicle 300 during the time segment 20. At least in the considered time segment 20 of the test acceleration 5, therefore, preferably no unit of the vehicle 300, in particular no vehicle actuator 314, acts on the reference wheel 378 in order to change its circumferential speed. No braking or acceleration torque is provided on the reference wheel 378. However, it is conceivable in principle that the reference wheel 378 is steered during the test acceleration 5 if the reference wheel 378 is a wheel of a steered axle. Preferably, however, the test acceleration 5 is carried out while the vehicle 5 is driving straight ahead, while the vehicle 300 is not steered. Accordingly, no manipulated variable 324 is preferably provided at a steering system 381 during the test acceleration 5.

Using the test speed signals 368, the control unit 202 of the driver assistance system 200 ascertains the test speed 372 during an ascertainment 21. The ascertainment 21 is thus carried out here on the basis of vehicle signals from the vehicle 300. However, it may also be provided that the driver assistance system 200 performs the ascertainment 21 of the test speed 372 using one or more speed sensors of the driver assistance system 200. The reference speed 376 of the reference wheel 378 is ascertained 23 by the control unit 202 using the reference speed signals 374. Similarly to ascertainment 21 of the test speed 372, however, ascertainment 23 of the reference speed 376 can also be carried out directly using at least one speed sensor of the driver assistance system 200. The signal-based approach described here is advantageous because wheel speed signals 368, which represent speeds of wheels 308, 310, 312 of the vehicle 300, are usually already provided on the vehicle network 334 for other purposes in modern vehicles 200. For example, in many modern vehicles 300, a stability control system 380, such as an Electronic Stability Control (ESC), ascertains rotational speeds or corresponding wheel speed signals 367 and provides them on the vehicle network 334. Preferably, the reference speed 376 can also be ascertained on the basis of GPS. In this case, a free-rolling reference wheel 378 can be dispensed with and all wheels 308, 310, 312 of the vehicle 300 can be braked with ascertainment 23 of the reference speed 376. For example, a reference speed 376 can be inferred from a speed of the vehicle 300, which is ascertained from GPS data, and a wheel circumference.

Following the simultaneous ascertainment 21 of the test speed 372 and the ascertainment 23 of the reference speed 376, the wheel slip 17 is ascertained on the basis of the test speed 372 and the reference speed 376 (ascertainment 19 in FIG. 3). In the embodiment described, this is particularly easy to do as the reference wheel 378 rolls freely. As a result, a relative speed between the reference wheel 378 and the road surface 344 is negligibly low, so that the wheel slip 17 is an amount of a difference between the reference speed 376 and the test speed 372.

Simultaneously with the ascertainment 19 of the wheel slip 17, an ascertainment 27 of a test manipulated variable 382 provided in the period 20 of the test braking 5 in order to act on the test wheel 352 takes place in the method 1. For a test braking operation 9, the test manipulated variable 382 (analogously to the manipulated variable 324) is the brake pressure pB, which is provided at the brake actuator 332c of the test wheel 352 or the left rear wheel 310a in order to provide a braking torque 313 at the test wheel 352 and thus act on the test wheel 352. Similarly, the test manipulated variable 382 for the positive test acceleration 11 is the drive torque 362 provided to the test wheel 352 by the drive motor 360. The brake signals 328 and the motor control signals 366 are provided on the vehicle network 334 so that the control unit 202 of the driver assistance system 200 can ascertain the test manipulated variable 382 associated with the test acceleration 5.

Furthermore, in the method 1 there is an ascertainment 29 of a test load characteristic 384 present on the test wheel 352 during the period 20, which in the present embodiment is an axle load 386 at the axle 304 of the vehicle 300 with which the test wheel 352 is associated. The test load characteristic 384 is thus here an axle load 386 of the rear axle 304 of the vehicle 300. The axle load 386 is ascertained by an air suspension system of the vehicle 300, which is not shown in the figures, wherein the air suspension system provides axle load signals 388 representing the axle load 386 on the vehicle network 334. The control unit 202 performs the ascertainment 29 of the test load characteristic 384 using these axle load signals 388. Signals already present on the vehicle network 334 can thus also be advantageously used for the ascertainment 29. The method 1 can thus be implemented particularly simply.

Based on the ascertained test load characteristic 384, the ascertained wheel slip 17 and the ascertained test manipulated variable 382, a reference friction value 33 is then ascertained 31. The test load characteristic 384, the wheel slip 17 and the test manipulated variable 382 characterize the reference friction value 33, but do not have to be used directly for the ascertainment 31. Rather, with the ascertainment 31, intermediate values can also be ascertained from the test load characteristic 384, the wheel slip 17 and/or the test manipulated variable 382. For example, a corresponding drive torque 362 or braking torque 313 of the test acceleration 5 can be ascertained from the test manipulated variable 382 via suitable correlations.

Further, in the embodiment shown, the reference friction value 33 is ascertained using environment data 35 provided by environment sensors 390 of the vehicle 300 on the vehicle network 334. For example, a windshield wiper 394 of the vehicle 300 provides windshield wiper signals 396 on the vehicle network 334 that can be used to infer road surface wetness of the road surface 344. Lastly, in the embodiment shown, the vehicle 300 includes an ambient temperature sensor 398 as a further environment sensor 390, the temperature signal 400 of which can be used by the control unit 202 of the driver assistance system 200 to ascertain an ambient temperature and to draw conclusions about the adhesion between the vehicle 300 and the road surface 344. An ascertainment 37 of environment data 35 described above by way of example using the ascertainment of the temperature signals 400 and the windshield wiper signals 396 is also illustrated in FIG. 3. However, the environment data 35 may also include, for example, a geographical location and/or a date. For example, there is a high probability of slippery roads in northern latitudes and in winter months, so that a geographical location of the vehicle 300 allows conclusions to be drawn about the friction value 7.

The reference friction value 33 is a friction value ascertained during a test acceleration 5. Compared to a regular acceleration of the vehicle 300, the test acceleration 5 has special features, which are explained using the normal braking 13 shown in FIG. 2A, the demand braking 15 illustrated in FIG. 2B and the positive test acceleration 11 shown in FIG. 2C.

The test braking 9 (FIG. 2A, which is configured as normal braking 13, is intended to fulfill a driving task of the vehicle 300. In the embodiment shown, the vehicle 300 is brought to a standstill in front of the red traffic light 338 by the normal braking 13. Normal braking 13 is therefore performed because there is a real deceleration requirement for the vehicle 300, which is not solely due to the ascertainment 31 of the reference friction value 33. To brake the vehicle 300 during the test braking 9 performed as normal braking 13, a braking torque 313 is applied to all wheels 308, 310, 312 with the exception of the reference wheel 378 or the left additional wheel 312a. Accordingly, a brake pressure pB is provided at all brake actuators 322 except for the brake actuator 322e of the reference wheel 378. By braking all wheels 308, 310, 312 of the vehicle 300 with the exception of the reference wheel 378, a deceleration of the vehicle 300 sufficient to fulfill the present driving task can be provided. The vehicle 300 is thus brought to a safe stop before the traffic light 338. Furthermore, it is advantageous that a normal braking operation 13 occurring during the driving operation of the vehicle 300 can be used to ascertain 31 the reference friction value 33. The normal braking 13 before the traffic light 338 is a moderate braking of about 1 m/s², so that no increased accident risk results from the exclusion of the reference wheel 378 from the test braking 9. Preferably, a brake force distribution of the vehicle 300 is adapted or a brake force redistribution is carried out as part of the moderate braking. In this way, the test wheel 352 can provide a particularly large proportion of the deceleration so that a high brake slip occurs. The increased brake slip facilitates the ascertainment 19 of the wheel slip and can improve the accuracy of the ascertainment 39 of the current friction value 7. The increased deceleration component of the test wheel 352 can be compensated for by reducing the braking power of further brake actuators 322 (or by redistributing the braking force from the other wheels to the test wheel 352). Furthermore, the period 20 is comparatively short with a value of 1.5 s, wherein all wheels 308, 310, 312 of the vehicle 300 can be used for braking without exception before and after the period 20.

In contrast to FIG. 2A, FIG. 2B does not illustrate normal braking 13, but rather demand braking 15. The demand braking 15 is only initiated for the purpose of ascertainment 31 of the reference friction value 33 and is not intended to fulfill a driving task of the vehicle 300. Thus, in the illustrated embodiment, the vehicle 300 is traveling at a moderate speed on a straight road surface 344, wherein there is no obstacle in front of the vehicle 300. In such a situation, demand braking 15 is uncritically possible. During demand braking 15, the speed 350 of the vehicle 300 should be kept substantially constant. Therefore, only the test wheel 352 is braked in the described embodiment of demand braking 15. In the period 20, a brake pressure pB is only provided at the brake actuator 322c of the test wheel 352 or the left rear wheel 310a, while all other brake actuators 322 of the vehicle 300 are vented. During demand braking 15, a braking torque 313 is only applied to the test wheel 352. In addition to the reference wheel 378, the front wheels 308, a right-hand rear wheel 310b and a right-hand auxiliary wheel 312b are also free-rolling. The demand braking 15 has little influence on the driving dynamics of the vehicle 300. Preferably, the reference wheel 378 for the demand braking 15 is a wheel 308, 310, 312 of a non-driven axle 302, 304, 306 of the vehicle 300, particularly preferably an additional wheel 312 of the additional axle 306. Thus, in many vehicles 300, particularly in commercial vehicles, a differential transmits forces or torques between the driven rear wheels 310 connected by the differential, which can falsify the result of the ascertainment 31. In particular with small brake pressures pB at the brake actuator 322c of the test wheel 352 and a short period 20, the demand braking 15 can also be performed unnoticed by a human driver of the vehicle 300, since no or only a small longitudinal deceleration of the vehicle 300 is built up. The negligible influence of the demand braking 15 on the travel of the vehicle 300 is to be illustrated in FIG. 2B by the fact that the vehicle 300 travels after the demand braking 15 at substantially the same speed 350 (illustrated by the length of the arrow extending in front of the vehicle 300 in the direction of travel 307) as before the demand braking 15.

FIG. 2C shows a positive test acceleration 11 of the vehicle 300, at which the speed 350 of the vehicle 300 increases along the path 335 in the direction of travel 307. In the positive test acceleration 11, the test wheel 352 is also the left rear wheel 310a and the reference wheel 378 is the left auxiliary wheel 312a. To perform 3 the positive test acceleration 11, the drive motor 360 acts on the test wheel 352 by providing a drive torque 362 to the test wheel 352. In contrast to demand braking 15, however, positive test acceleration 11 also acts on a right rear wheel 310b in addition to the test wheel 352. All other wheels 308, 312 of the vehicle 300, that is, also the additional left wheel 312a forming the reference wheel 378, are free-rolling. Since the reference wheel 378 and the test wheel 352 are arranged on different axles 302, 304, 306 of the vehicle 300, a drive torque 362 can advantageously be provided on all wheels 310 of the driven rear axle 304. A reference friction value 33 is ascertained at a uniform or symmetrical positive acceleration of the vehicle 300. Thus, a normal acceleration 402 of the vehicle 300 can be used to ascertain 31 the reference friction value 33. The normal acceleration 402 is used to fulfill a driving task of the vehicle 300 and is illustrated in FIG. 2C by the vehicle 300 driving away from the traffic light 338, which shows a green signal in FIG. 2C.

It should be understood that during operation of the vehicle 300, both positive test accelerations 11 and normal braking 13 and demand braking 15 can preferably be used to ascertain 31 the reference friction value 33. Thus, in the embodiments shown of all these test accelerations 5, the wheel slip 17 is ascertained from the test speed 372 of the test wheel 352 and the reference speed 376 of the reference wheel 378 and is used together with respectively ascertained test load characteristics 384 and respectively ascertained test manipulated variables 382 to ascertain 31 corresponding reference friction values 33. In this way, an increasingly larger friction value database can be created over the service life of the vehicle 300, which has a corresponding reference friction value 33 for a large number of driving situations and loads of the vehicle 300.

The reference friction values 33 ascertained during one or more test accelerations 5 can then be used to ascertain a simplified current friction value 7 during operation of the vehicle 300 (ascertainment 39 in FIG. 3). The current friction value 7 is the friction value 7 present between the wheels 308, 310, 312 of the vehicle 300 and the road surface 344 in an operating driving situation 404 under consideration, which can change rapidly during operation of the vehicle 300. For example, a road surface of the traveled road surface 344 may change suddenly or the current friction value 7 may be reduced as a result of wet leaves on the road surface 344. It is therefore advantageous during operation of the vehicle 300 to monitor the current friction value 7 closely or to ascertain it within short periods. This is particularly desirable if a change in the movement state of the vehicle 300 is planned, that is, in particular if the vehicle 300 is to be steered, braked or positively accelerated. In the embodiment of the method 1 shown, the ascertainment 39 of the current friction value 7 is preceded by an ascertainment 41 of an operating wheel slip 43 of the test wheel 352 in an operating driving situation 404. The operating wheel slip 43 can, for example, be ascertained using signals provided by the stability control system 380 on the vehicle network 334 and evaluated by the control unit 202 of the driver assistance system 200. However, the ascertainment 41 of the operating wheel slip 43 can also be carried out directly by the driver assistance system on the basis of sensors. Furthermore, the control unit 202 of the driver assistance system 200 ascertains a current load characteristic 406, which corresponds to the test load characteristic 384, during an ascertainment 45 carried out simultaneously with the ascertainment 41 of the operating wheel slip 43. The current load characteristic 406 in the operating driving situation 404, for which the current friction value 7 is ascertained, is therefore also an axle load 386 on the rear axle 304. To act on the test wheel 352 in the operating driving situation 404, a manipulated variable 408 is provided to or by a vehicle actuator 314 associated with the test wheel 352. The manipulated variable 408 corresponds to the test manipulated variable 382 and can be ascertained in a step illustrated in FIG. 3 as ascertainment 47. If the operating driving situation 404 is an acceleration, then the manipulated variable 408 here is a drive torque 362 of the drive motor 360. In the case of an operating driving situation 404, which is a braking of the vehicle 300, a brake pressure pB provided at the brake actuator 322c of the left rear wheel 310a forms the manipulated variable 408. The advantage of ascertainment 41 of the operating wheel slip 43 is that preferably no wheel 308, 310, 312 of the vehicle 300 has to be excluded from braking 336, so that the full braking power of the brake system 316 is available for decelerating the vehicle 300.

After ascertainment 45 of the current load characteristic 406, ascertainment 41 of the operating wheel slip 43 and ascertainment 47 of the manipulated variable 408, the current friction value 7 is ascertained 39 in the method 1 according to FIG. 3. In the embodiment shown, this ascertainment 39 is a selection 49 of a corresponding reference friction value 33. Here, a reference friction value 33 is selected as the current friction value 7 of which the load characteristic 406 lies within a load tolerance 410 around the test load characteristic 384 of the reference friction value 33, of which the operating wheel slip 43 lies within a slip tolerance 412 around the wheel slip 17 and of which the manipulated variable 408 lies within a manipulated variable tolerance 414 around the test manipulated variable 382. Preferably, a tolerance width of the load tolerance 410, the slip tolerance 412 and/or the manipulated variable tolerance 414 is adapted as a function of a number of available reference friction values 33. Thus, the tolerances 410, 412, 414 can be small with a large database and large with a small database.

In the embodiment of the method 1 according to FIG. 3, the current friction value 7 is used to perform 51 a subsequent operation 53 following the ascertainment 39. The subsequent operation 53 is here a provision 55 of a warning signal 57 at a warning light 416 of the vehicle 300. Furthermore, an electrical warning signal 59 is provided by the control unit 202 of the driver assistance system 200 on the vehicle network 334. The electrical warning signal 59 is thus also present at the autonomous unit 332 and can be used by it when ascertaining the trajectory 333. Furthermore, the stability control system 380 can be set to a preventive control mode 418 via the electrical warning signal 59, in that the stability control system 380 can detect and compensate for any instabilities of the vehicle 300 at an early stage. Furthermore, the stability control system 380 can adapt a brake pressure for any intervention to the ascertained friction value 7. In the present embodiment, however, the stability control system 380 is only set to preventive control mode 418 if the current friction value 7 falls below a friction value limit value 61. Thus, stabilizing interventions of the stability control system 380 are usually only necessary when the current friction value 7 is comparatively low, as is the case, for example, when the road surface 344 is icy.

It is understood that the foregoing description is that of the preferred

embodiments of the invention and that various changes and modifications may be made thereto without departing from the spirit and scope of the invention as defined in the appended claims.

### REFERENCE SIGNS (PART OF THE DESCRIPTION)

1 method
3 performance of a test acceleration
5 test acceleration
7 current friction value
9 test braking
11 positive test acceleration
13 normal braking
15 demand braking
17 wheel slip
19 ascertainment of wheel slip
20 period
21 ascertainment of a test speed
23 ascertainment of a reference speed
27 ascertainment of a test manipulated variable
29 ascertainment of a test load characteristic
31 ascertainment of a reference friction value
33 reference friction value
35 environment data
37 ascertainment of environment data
39 ascertainment of a current friction value
41 ascertainment of an operating wheel slip
43 operating wheel slip
45 ascertainment of a current load characteristic
47 ascertainment of a manipulated variable
49 selecting a corresponding reference friction value
51 performing a subsequent operation
53 subsequent operation
55 providing a warning signal
57 warning signal
59 electrical warning signal
61 friction value limit
200 driver assistance system
202 control unit
204 interface
300 vehicle
302 front axle
304 rear axle
306 liftable additional axle, lift axle
307 direction of travel
308 front wheels
308a left front wheel
310, 310a, 310b rear wheels
312 additional wheels
313 braking torque
314 vehicle actuators
316 brake system
318 brake control unit
320 brake modulator
322, 322a, 322b,
322c, 322d brake actuators
324 manipulated variable
326 brake system
328 brake signals
330 foot brake pedal
332 autonomous unit
333 trajectory
334 vehicle network
335 path
336 braking
337 speed profile
338 traffic light
344 road surface
346 braking distance
348 manipulated variable signals
350 speed of the vehicle
352 test wheel
354 commercial vehicle
356 maximum load axis
358 axle load
360 drive motor
362 drive torque
364 motor control unit
366 motor control signals
368 wheel speed signals
370 test speed signal
372 test speed
374 reference speed signal
376 reference speed
378 reference wheel
380 stability control system
381 steering
382 test manipulated variable
384 test load characteristic
386 axle load
388 axle load signals
390 environment sensors
394 windshield wiper
396 windshield wiper signals
398 ambient temperature sensor
400 temperature signal
402 normal acceleration
404 operating driving situation
406 load characteristic
408 manipulated variable
410 load tolerance
412 slip tolerance
414 manipulated variable tolerance
416 warning light
418 control mode
pB brake pressure

1. A method for approximating a friction value between wheels of a vehicle and a road surface, the method comprising:
carrying out at least one test acceleration of the vehicle by acting on at least one test wheel;
determining a wheel slip of the at least one test wheel for at least one period of the at least one test acceleration;
determining a test manipulated variable provided during the at least one period in order to act on the at least one test wheel;
determining a test load characteristic present on the at least one test wheel during the at least one period; and,
determining a reference friction value for the at least one test acceleration on a basis of the determined test load characteristic, the determined test manipulated variable and the
determined wheel slip of the at least one test wheel.

2. The method of claim 1, wherein the determining of the wheel slip of the at least one test wheel for at least a period of the at least one test acceleration includes:
determining a test speed of the at least one test wheel;
determining a reference speed of a reference wheel;
determining the wheel slip on a basis of the determined test speed and the determined reference speed, wherein at least one of the following applies:
i) the reference wheel is a wheel rolling freely in the period; and,
ii) the reference speed is determined on the basis of a vehicle speed of the vehicle and a wheel circumference of the reference wheel.

3. The method of claim 2, wherein the at least one test wheel and the reference wheel are associated with different axles of the vehicle.

4. The method of claim 1, wherein the at least one test wheel is a wheel of a rear axle of the vehicle.

5. The method of claim 1, further comprising:
determining an operating wheel slip of the at least one test wheel in an operating driving situation;
determining a current load characteristic of the vehicle in the operating driving situation;
determining a manipulated variable provided in the operating driving situation to act on the at least one test wheel;
determining a current friction value of the operating driving situation by selecting a corresponding reference friction value;
wherein the reference friction value corresponds to the current friction value when the determined load characteristic lies within a load tolerance around the test load characteristic, the operating wheel slip lies within a slip tolerance around the wheel slip and the manipulated variable lies within a manipulated variable tolerance around the test manipulated variable.

6. The method of claim 5, further comprising,
carrying out a subsequent operation using the current friction value, wherein the subsequent operation includes providing a warning signal, placing a stability control system in a preventive control mode; re-determining a trajectory of the vehicle, providing a speed reduction request, determining a degree of freedom of movement limit, wherein at least one of the following applies:
i) limiting a degree of freedom of movement of the vehicle; and,
ii) validating a friction value sensor,
wherein the subsequent operation is only carried out if the current friction value falls below a friction value limit.

7. The method of claim 1, wherein:
the at least one test acceleration is a test braking of the vehicle;
the test manipulated variable is a brake pressure provided at a brake actuator associated with the at least one test wheel; and,
wherein the reference wheel is excluded from the test braking, so that no brake pressure is provided at the brake actuator associated with the reference wheel during the at least one period.

8. The method of claim 7, wherein during the at least one period only the reference wheel is excluded from the test braking.

9. The method of claim 7, wherein the test braking is a normal braking performed in a normal driving mode of the vehicle to fulfill a driving task.

10. The method of claim 7, further comprising a braking force redistribution wherein further braked wheels of the vehicle compensate for the lack of deceleration of the reference wheel excluded from the test braking.

11. The method of claim 7, wherein only the at least one test wheel is braked in the at least one period.

12. The method of claim 11, wherein the test braking is a demand braking initiated to determine the reference friction value, which is initiated without an associated deceleration requirement of the vehicle, wherein the demand braking is initiated when the vehicle is traveling straight ahead.

13. The method of claim 7, wherein the test braking is a moderate braking in a range of greater than at least one of 0 m/s² to 2 m/s² and 1 m/s² to 2 m/s².

14. The method of claim 1, wherein the at least one test acceleration is a positive acceleration of the vehicle, the test manipulated variable is a driving torque provided at the test wheel, and wherein no driving torque is provided at the reference wheel in the at least one period.

15. The method of claim 1, wherein the test load characteristic is or includes an axle load on a test axle of the vehicle on which the at least one test wheel is arranged, a wheel load of the at least one test wheel, a mass distribution of the vehicle, a total mass of the vehicle, a partial mass of a vehicle part on which the at least one test wheel is arranged, and at least one of the following: applies:
i) a center of gravity position of the vehicle; and,
ii) a center of gravity position of a vehicle part.

16. A driver assistance system configured to perform the following method for approximating a friction value between wheels of a vehicle and a road surface, the method comprising:
carrying out at least one test acceleration of the vehicle by acting on at least one test wheel;
determining a wheel slip of the at least one test wheel for at least one period of the at least one test acceleration;
determining a test manipulated variable provided during the at least one period in order to act on the at least one test wheel;
determining a test load characteristic present on the at least one test wheel during the at least one period; and,
determining a reference friction value for the at least one test acceleration on a basis of the determined test load characteristic, the determined test manipulated variable and the determined wheel slip of the at least one test wheel.

17. A vehicle comprising at least two axles, a brake system, a steering system, a drive motor and a driver assistance system configured to perform the following method for approximating a friction value between wheels of a vehicle and a road surface, the method including:
carrying out at least one test acceleration of the vehicle by acting on at least one test wheel;
determining a wheel slip of the at least one test wheel for at least one period of the at least one test acceleration;
determining a test manipulated variable provided during the at least one period in order to act on the at least one test wheel;
determining a test load characteristic present on the at least one test wheel during the at least one period; and,
determining a reference friction value for the at least one test acceleration on a basis of the determined test load characteristic, the determined test manipulated variable and the determined wheel slip of the at least one test wheel.

18. A computer program product comprising program code stored on a non-transitory computer-readable medium;
said program code being configured, when executed by a processor to carry out a method for approximating a friction value between wheels of a vehicle and a road surface, the method comprising:
carrying out at least one test acceleration of the vehicle by acting on at least one test wheel;
determining a wheel slip of the at least one test wheel for at least one period of the at least one test acceleration;
determining a test manipulated variable provided during the at least one period in order to act on the at least one test wheel;
determining a test load characteristic present on the at least one test wheel during the at least one period; and,
determining a reference friction value for the at least one test acceleration on a basis of the determined test load characteristic, the determined test manipulated variable and the determined wheel slip of the at least one test wheel.

19. The method of claim 1, wherein the at least one test wheel is a wheel of an auxiliary axle of the vehicle.
